(19) United States
(12) Patent Application Publication
(10) Pub. No.: US 2025/0231096 A1
(43) Pub. Date: Jul. 17, 2025

(54) DEVICE FOR MEASURING THE MEDIAN RADIUS OF BUBBLES IN A FOAMED PLASTER BLEND

(71) Applicants: SAINT-GOBAIN PLACO, COURBEVOIE (FR); CENTRE NATIONAL DE LA RECHERCHE SCIENTIFIQUE, PARIS (FR); UNIVERSITE PARIS CITE, PARIS (FR)

(72) Inventors: Valentin LEROY, PARIS (FR); Ivan BERLINE, AUBERVILLIERS (FR); Claire SCHUNE, CONFLANS-SAINTE-HONORINE (FR)

(21) Appl. No.: 18/853,653

(22) PCT Filed: Apr. 7, 2023
(86) PCT No.: PCT/EP2023/059332

§ 371 Date: Oct. 2, 2024

(30) Foreign Application Priority Data
Apr. 8, 2022 (FR) FR2203268

(51) Int. Cl. G01N 15/08; G01N 15/00; G01N 29/032; G01N 29/22; G01N 29/34

(52) U.S. Cl. CPC G01N 15/088; G01N 15/0806; G01N 2015/0011; G01N 2015/0015; G01N 29/032; G01N 29/222; G01N 29/343; G01N 2291/015; G01N 2291/02433; G01N 2291/0421; G01N 2291/048

(57) ABSTRACT

A method for determining a median radius R₀ of a collection of bubbles in a foamed medium, which liquid is suitable for being cured and to form, after curing, a solid construction material or a solid polymer foam, the method including conveying the foamed medium into a cavity, transmitting an ultrasound pulse into the cavity, detecting the pulse, measuring a component chosen from an amplitude of the detected pulse and a phase of the pulse, and subsequently determining the median radius Ro of the bubbles in the foamed medium in the cavity on the basis of the determined component.

### FIELD OF THE INVENTION

The present invention relates to the manufacture of a blend, more particularly a foamed plaster blend. In particular, it concerns a method for determining the median radius of bubbles in a foamed plaster blend, and a device for carrying out such a method.

### STATE OF THE ART

The manufacture of plaster is energy-intensive, and it is desirable to reduce the energy required to produce it. For this purpose, it is known to increase the volume fraction of air in plaster by introducing air into a blend of plaster in the form of bubbles. In this way, it is possible to reduce the amount of water used to manufacture a predetermined volume of plaster, and thus reduce the total energy used to manufacture the blend.

However, as plaster is an opaque material, it is impossible to optically monitor the median radius of bubbles formed inside the blend non-destructively. Still, it is necessary to control the median radius of the bubbles, since this radius controls the mechanical characteristics of the plaster after the blend has set.

For this purpose, it is known to measure the median radius of air bubbles in a plaster blend or in plaster that has already set using X-ray tomography. However, this method is complex, costly and does not allow in-line measurements.

### SUMMARY OF THE INVENTION

One aim of the invention is to propose a solution for simplifying a measurement of a median radius of a collection of bubbles formed in a liquid medium with regard to a measurement implemented by X-ray tomography.

This aim is achieved within the framework of the present invention by a method of determining a median radius R₀ of a collection of bubbles comprised in a liquid foamed medium adapted to be cured and to form, after curing, a solid construction material or a solid polymer foam, the foamed medium having a liquid phase and a gaseous phase formed by the collection of bubbles, and having a predetermined gaseous volume fraction φ of between 0.05 and 0.8 inclusive, the method comprising the steps of:
a) conveying the foamed medium into a cavity,
b) transmitting an ultrasound pulse to the cavity by an ultrasound pulse transmitter,
c) detecting the pulse by an ultrasound pulse detector,
d) determining, on the basis of the pulse detected in step c) and a reference pulse, at least one feature selected from transmission T of the pulse through the cavity and reflection R of the pulse on a surface delimiting the cavity,
e) determining the median radius R₀ of the collection of bubbles from the element(s) determined in step d) and the predetermined gas volume fraction φ.

The present invention is advantageously completed by the following features, taken individually or in any of their technically possible combinations:
the foamed medium is non-transparent,
a predetermined gas volume fraction φ is in particular between 0.1 and 0.8 inclusive, preferentially between 0.15 and 0.7, preferentially between 0.15 and 0.5,
the cavity has a width l, and the transmitter and detector are arranged on either side of the width l of the cavity so that the pulse propagates in the foamed medium along the width l of the cavity, and, in step d), the transmission T of the pulse through the cavity is determined, the method is adapted to determine a predetermined maximum median radius R₀ₘₐₓ of the collection of bubbles, and, in step b), the pulse is transmitted at a transmission frequency fₜ strictly greater than a permitted propagation frequency fₚₚ equal to (\sqrt{3φ}·c₀)/(2π·R₀ₘₐₓ), c₀ being the pulse velocity in the liquid phase of the foamed medium,
the cavity has a width l, and wherein the transmitter and detector are arranged on either side of the width l of the cavity so that the pulse propagates in the foamed medium along the width l of the cavity, and wherein, in step d), the transmission T of the pulse through the cavity is determined, the method being adapted to determine a predetermined median radius R₀ of the collection of bubbles that is less than a predetermined maximum median radius R₀ₘₐₓ of the collection of bubbles, wherein, in step b), the pulse is transmitted at a transmission frequency fₜ strictly greater than a permitted propagation frequency fₚₚ equal to (\sqrt{3φ}·c₀)/(2π·R₀ₘₐₓ), c₀ being the pulse velocity in the liquid phase of the foamed medium,
the cavity has a width l, the transmitter and detector are arranged on either side of the width l of the cavity so that the pulse propagates in the foamed medium along the width l of the cavity, in step d) the transmission T of the pulse through the cavity is determined, the method is adapted to determine a predetermined maximum median radius R₀ₘₐₓ of the collection of bubbles, and, in step b), the pulse is transmitted at a transmission frequency fₜ strictly less than a sensitivity limit frequency fₗₛ of between 4·(\sqrt{3φ}·c₀)/(2π·R₀ₘₐₓ) and 10·(\sqrt{3φ}·c₀)/(2π·R₀ₘₐₓ) and preferably between 4·(\sqrt{3φ}·c₀)/(2π·R₀ₘₐₓ) and 6·(\sqrt{3φ}·c₀)/(2π·R₀ₘₐₓ),
the cavity has a width l, the transmitter and detector are arranged on either side of the width l of the cavity so that the pulse propagates in the foamed medium along the width l of the cavity, in step d) the transmission T of the pulse through the cavity is determined, the method being adapted to determine a median radius R₀ of the collection of bubbles that is less than a predetermined maximum median radius R₀ₘₐₓ of the collection of bubbles, and, in step b), the pulse is transmitted at a transmission frequency fₜ strictly less than a sensitivity limit frequency fₗₛ of between 4·(\sqrt{3φ}·c₀)/(2π·R₀ₘₐₓ) and 10·(\sqrt{3φ}·c₀)/(2π·R₀ₘₐₓ), and preferably between 4·(\sqrt{3φ}·c₀)/(2π·R₀ₘₐₓ) and 6·(\sqrt{3φ}·c₀)/(2π·R₀ₘₐₓ),
the method is devoid of a step wherein a pulse with a frequency lower than the permitted propagation frequency fₚₚ is transmitted,
the transmission frequency fₜ is between 0.4 MHz and 56 MHz,
the cavity has a width l, and the transmitter and detector are arranged on either side of the width l of the cavity so that the pulse propagates in the foamed medium along the width l of the cavity, in step d), the transmission T of the pulse through the cavity is determined, the width l being less than 5 mm, in particular 2 mm, and more preferentially 0.8 mm,
in step e), the median radius R₀ is determined from the gas volume fraction φ, from the component, and from the width l,
in step e), the median radius R₀ is determined from an attenuation factor α representative of the attenuation of the pulse amplitude in the foamed medium along the width l,
in step a), a flow of foamed medium is driven into a channel comprising the cavity, and transmission step b) and detection step c) are implemented during the flow,
the foamed medium comprises at least one member selected from a foam and a blend, preferably at least one member selected from a plaster blend, a cement blend, a lime blend, a mortar blend, a polyurethane foam and a polyisocyanurate foam,
in step b), the pulse has a duration of between 0.03 μs and 10 μs,
in step d), the component is determined from the start of the pulse to a predetermined duration, the predetermined duration preferentially being less than 5 μs,
the cavity has a width l, and the transmitter and detector are arranged on either side of the width l of the cavity so that the pulse propagates along the width l of the cavity and wherein the pulse is a longitudinal ultrasound pulse,
the cavity has a width l, and the transmitter and detector are arranged on either side of the width l of the cavity, so that the pulse propagates in the foamed medium along the width l of the cavity, in step d), the transmission T of the pulse through the cavity is determined, and in step e), a modulus of a complex transmission |T| of the pulse through the cavity is determined at least from the transmission T, and the median radius R₀ is determined from the ratio defined by:

$$\frac{A}{B - {g}_{1} ( l , φ , \vert T \vert )}$$

A being a distance between 20 μm and 500 μm and in particular between 100 μm and 150 μm, B being a dimensionless number between 0.1 and 1 and in particular between 0.2 and 0.6, and g, being a function having as variables the width l expressed in mm, the gas volume fraction φ and the modulus of the complex transmission |T|, the function g, is equal to

$$\frac{E}{l \cdot φ} ln \vert T \vert$$

E is a constant value, preferably between 0.01 mm and 0.5 mm,
step e) for determining the median radius R₀ of the collection of bubbles is carried out without using the resonant frequency of the collection of bubbles,
wherein the pulse is transmitted at a transmission frequency fₜ of between 0.4 MHz and 56 MHz.

Another aspect of the invention is a device for determining a median radius R₀ of a collection of bubbles comprised in a liquid foamed medium adapted to be cured and to form, after curing, a solid construction material or a solid polymer foam, the foamed medium having a liquid phase and a gaseous phase formed by the collection of bubbles, and having a predetermined gaseous volume fraction φ of between 0.05 and 0.8 inclusive, the device comprising:
a cavity adapted to receive the foamed medium,
an ultrasound pulse transmitter arranged to transmit an ultrasonic wave towards the cavity,
an ultrasound pulse detector arranged to detect an ultrasound pulse and,
a control unit configured to:
   determine, on the basis of a pulse detected by the detector and a reference pulse, at least one feature selected from transmission T of the pulse through the cavity and reflection R of the pulse on a surface delimiting the cavity, and to
   determine the median radius R₀ of the collection of bubbles from the determined element(s) and the predetermined gas volume fraction φ.

Advantageously, the cavity has a width l, the transmitter and receiver are arranged on either side of the width l of the cavity so that the pulse propagates across the width l of the cavity, and the width l is preferentially less than 5 mm, in particular 2 mm, and more preferentially 0.8 mm.

Advantageously, the device comprises a channel adapted for the flow of the foamed medium, the channel comprising the cavity.

Advantageously, the device is configured to measure a predetermined maximum median radius R₀ₘₐₓ of the collection of bubbles, the transmitter comprising a first transducer extending along a length L in a direction perpendicular to a direction of pulse transmission by the transmitter, the length L being greater than 30·R₀ₘₐₓ and preferentially than 50·R₀ₘₐₓ.

### DESCRIPTION OF THE FIGURES

Other features, purposes and advantages of the invention will emerge from the following description, which is purely illustrative and non-limiting, and which must be read in conjunction with the appended drawings in which:

FIG. 1 schematically shows a method according to one embodiment of the invention,

FIG. 2 schematically shows a device according to one embodiment of the invention,

FIG. 3 shows a variation in the attenuation of an ultrasound pulse transmitted through a device cavity, as a function of pulse frequency,

FIG. 4 shows a variation of the real part of the Napierian logarithm of the transmission of a pulse through a cavity filled with a foamed medium comprising bubbles, as a function of the median radius of the bubbles,

FIG. 5 shows a device according to one embodiment of the invention adapted to allow the liquid medium to flow into the cavity,

FIG. 6 shows calibration of a device according to one embodiment of the invention.

In all the figures, similar elements are marked with identical references.

### Definitions

“Non-transparent” means a foamed medium, arranged in a cavity of predetermined geometry, with a haze factor greater than 1%, in particular greater than 5% and preferably greater than 10%.

The “haze factor” is the ratio between the intensity of a light beam diffused by a passing through the medium (diffuse fraction) at an angle greater than 2.5° and the intensity of a light beam transmitted through the medium. The haze factor may be measured by spectroscopy techniques. The integration of the intensity over the whole of the visible range (from 380 nm to 780 nm) makes it possible to determine the normal transmission T_{L} and diffuse transmission T_{d}. Such a measurement may also be obtained using a Hazemeter.

The “median radius R₀ of a collection of bubbles” is the median radius R₀ determined from a distribution of radii, the distribution being formed by the radii of each bubble in the collection of bubbles.

Pulse transmission T means a quantity determined from a pulse detected after propagation of the pulse through a predetermined quantity of a foamed medium in a cavity and from a reference pulse. A pulse reflection R is a quantity determined from a pulse detected after the pulse is reflected on a surface delimiting the cavity and from a reference pulse.

Preferably, “complex transmission T” of a pulse transmitted through a predetermined quantity of foamed medium in a cavity is defined as the ratio between the complex Fourier transform, at transmission frequency fₜ, of the pulse transmitted through a cavity, for a cavity filled with foamed medium, and between the Fourier transform at frequency fₜ, for a cavity filled with water. The transmission T and/or reflection R of a pulse can be determined at 25° C.

In a system formed by a cavity of width l, formed by a first material, and comprising the medium to be measured, the complex transmission T of a pulse can be the quantity defined by the formula described in the following equation (1):

$$T = \frac{z}{{z}_{0}} \frac{{( {z}_{p} + {z}_{0} )}^{2}}{{( {z}_{p} + z )}^{2}} \cdot {e}^{i . l . ( k - {k}_{0} )} \qquad ( 1 )$$

where Z is the acoustic impedance of the medium being measured, Zₚ is the acoustic impedance of the first material, Z₀ is the impedance of the water in the cavity, k is the wavenumber for pulse propagation in the medium being measured and k₀ is the wavenumber for pulse propagation in the liquid phase of the medium being measured.

The “attenuation d” of a pulse propagating through a cavity of width l is the linear attenuation defined by α=−ln|T|/l. Preferably, the attenuation is measured for a pulse propagating through the cavity filled with a bubble-free liquid medium identical to the medium of the liquid phase of the foamed medium.

A “solid construction material” is any solid material suitable for use in a construction project. A solid construction material can be plaster, mortar, lime, cement, concrete and/or a coating.

### DETAILED DESCRIPTION OF THE INVENTION

### General Principle for Determining the Median Radius R₀ of a Collection of Bubbles 1

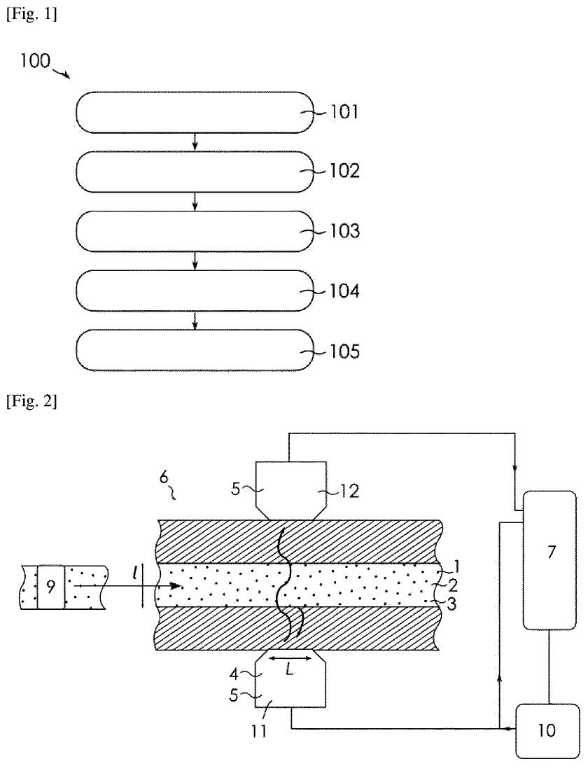

With reference to FIG. 1 and FIG. 2, one aspect of the invention is a method 100 for determining a median radius R₀ of a collection of bubbles 1 comprised in a liquid foamed medium 2 adapted to be cured and to form, after curing, a solid construction material or solid polymer foam. The foamed medium 2 can be a non-transparent medium, in particular an opaque medium.

The foamed medium 2 has a liquid phase and a gaseous phase formed by the collection of bubbles. The foamed medium 2 has a predetermined gas volume fraction φ of between 0.05 and 0.8 inclusive. The gas volume fraction φ can be predetermined by mixing a predetermined volume of bubble-free liquid with a predetermined volume of gas. The predetermined gas volume fraction φ can be confirmed or determined by weighing the foamed medium after the gas has been introduced into the liquid.

The method 100 comprises a step of conveying 101 the foamed medium 2 into a cavity 3. The cavity 3 is filled with foamed medium 2. A sample of the foamed medium 2 can be taken and poured into a cavity 3 to fill the cavity 3.

The method 100 comprises a step of transmitting 102 an ultrasound pulse to cavity 3 by an ultrasound pulse transmitter 4. The ultrasound pulse can then be transmitted through the cavity 3 or reflected by the cavity 3.

The method 100 comprises a pulse detection step 103 by an ultrasound pulse detector 5.

The method 100 comprises a step of determining 104, on the basis of the pulse detected in step 103 and a reference pulse, at least one feature selected from transmission T of the pulse through the cavity 3 and reflection R of the pulse on a surface delimiting the cavity 3.

Following the step 104 of determining at least one element, the method 100 comprises a step 105 of determining the median radius R₀ of the collection of bubbles 1 from the element(s) determined in step 104 and from the predetermined gas volume fraction φ.

In this way, the transmission of the pulse through the cavity 3 or reflection of the pulse on the cavity 3 stresses the bubbles in the foamed medium 2, each of the bubbles acting as a local acoustic diffuser. The detected pulse comprises the contributions of each of the local diffusers formed by the bubbles, and the detection of the transmitted or reflected pulse makes it possible to determine the median radius R₀ in the volume fraction range between 0.05 and 0.8.

Measuring the median radius of the bubbles is therefore simpler than using X-ray tomography.

### Pulse Transmission Frequency f_{T}

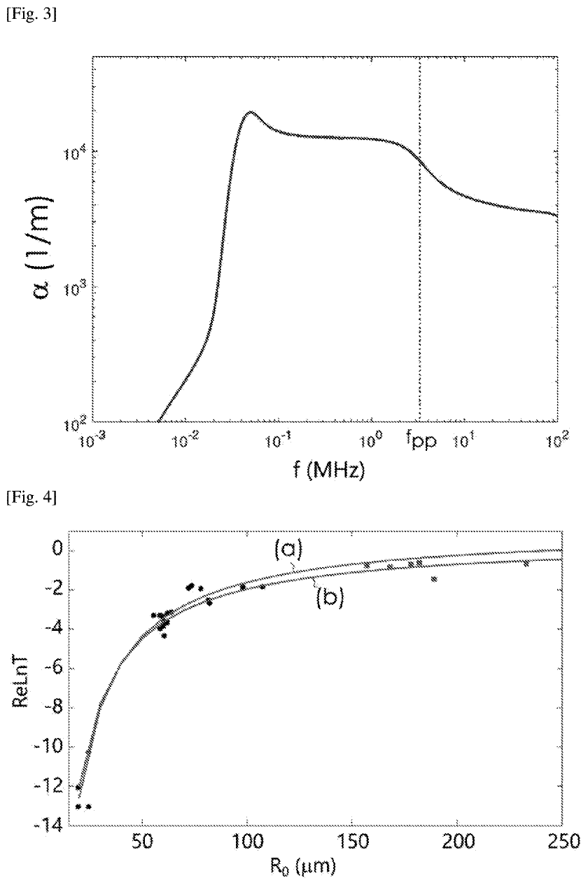

The method 100 can be adapted to determine a predetermined maximum median radius R₀ₘₐₓ of the collection of bubbles. In other words, the method 100 can be adapted to determine a median radius R₀ of the collection of bubbles that is smaller than a maximum median radius R₀ₘₐₓ of the predetermined collection of bubbles. The cavity 3 can have a width l. The transmitter 4 and detector 5 can be arranged on either side of the width l of the cavity 3 so that the pulse propagates in the foamed medium 2 along the width l of the cavity 3. This configuration enables pulse detection by pulse transmission. Referring to FIG. 3, in the transmission step 102, the pulse can be transmitted at a transmission frequency fₜ strictly higher than a permitted propagation frequency f_{PP}. The frequency f_{PP} is equal to (\sqrt{3φ}·c₀)/(2π·R₀ₘₐₓ), c₀ being the pulse velocity in the liquid phase of the foamed medium 2, in particular one that is bubble-free. In this way, the pulse can be transmitted by propagation through the cavity. At frequencies fₜ below the permitted propagation frequency f_{PP}, pulse transmission is due to an evanescent field in the cavity 3. In an evanescent field, the attenuation is very high compared to the attenuation in the propagation field, making it impossible to detect the pulse. For this reason, the frequency fₜ may be higher than the frequency fₚₚ.

The method 100 can be adapted to determine a maximum median radius of less than 700 μm, in particular 250 μm. For a maximum median radius R₀ₘₐₓ equal to 250 μm and a gas volume fraction φ equal to 0.05, the permitted propagation frequency fₚₚ is equal to 0.4 MHz. The transmission frequency fₜ can be higher than 0.4 MHz, particularly when the foamed medium 2 is a blend, notably higher than 1 MHz and preferably higher than 4 MHz.

The method 100 can be adapted to determine a minimum median radius R₀ₘᵢₙ greater than 20 μm.

FIG. 3 shows the attenuation α of a pulse transmitted through the cavity 3 comprising a foamed medium 2 with a gas volume fraction φ equal to 0.35 and bubbles with a median radius R₀ equal to 75 μm.

With reference to FIG. 4, the method 100 can be adapted to determine a predetermined maximum median radius R₀ₘₐₓ of the collection of bubbles 1. In the transmission step 102, the pulse can be transmitted at a transmission frequency fₜ strictly below a sensitivity limit frequency fₗₛ between 4·(\sqrt{3φ}·c₀)/(2π·R₀ₘₐₓ) and 10·(\sqrt{3φ}·c₀)/(2π·R₀ₘₐₓ) and preferably between 4·(\sqrt{3φ}·c₀)/(2π·R₀ₘₐₓ) and 6·(\sqrt{3φ}·c₀)/(2π·R₀ₘₐₓ). In this way, it is possible to increase the sensitivity of the median radius R₀ determination when the median radius R₀ tends towards R₀ₘₐₓ. Indeed, the sensitivity of detecting the median radius R₀ is significantly higher when fₜ is less than fₗₛ compared to when fₜ is greater than fls.

The sensitivity limit frequency fₗₛ can be between 2.5 MHz and 140 MHz, preferably between 3 MHz and 10 MHz.

The method 100 may be devoid of a frequency fₜ sweep. In fact, pulse detection at a single frequency fₜ can be used to determine the median radius R₀. The transmitted pulse can have a frequency spectrum centered on the transmission frequency fₜ. The method 100 may be devoid of a step in which a pulse with a frequency lower than the permitted propagation frequency fₚₚ is transmitted. In this way, the determination of the resonant frequency of the bubbles in a foamed medium can be eliminated in order to determine the median radius R₀, thus speeding up and simplifying the determination of the median radius R₀ relative to a method wherein the acquisition of a frequency spectrum covering the resonant frequency of the foamed medium would be necessary.

Determining the Median Radius R₀ from the Element

The cavity 3 can have a width l, and the transmitter 4 and detector 5 can be arranged on either side of the width l of the cavity 3 so that the pulse propagates in the foamed medium 2 along the width l of the cavity. In step d), the transmission T of the pulse through the cavity 3 can be determined. In determination step 105, the median radius R₀ can be determined from the gas volume fraction φ, from the component, and from the width l.

Preferably, the median radius R₀ can be determined by evaluating a radius determination function g_{dr} having as variables the gas volume fraction φ, the width l, and the complex transmission T The radius determination function g_{dr} can have as a variable the modulus |T| of the complex transmission.

The well-known independent scattering approximation model (ISA, described in Sheng P., 2006, Introduction to wave scattering, localization and mesoscopic phenomena, Vol. 88, Springer Science & Business Media) does not allow the median radius R₀ to be determined for a gas volume fraction φ greater than 2%.

To this end, the inventors have developed a phenomenological model based on data comprising pairs associating the complex transmission T with the median radius R₀.

With reference to FIG. 4, the median radius R₀ can be determined from a predetermined function by a fit defined from a set of element series, each element series comprising at least one predetermined median radius R₀ᵢ and a complex transmission T associated with the median radius R₀. Each series can also comprise a gas volume fraction φ associated with the median radius R₀ᵢ, and/or a width l associated with the median radius R₀ᵢ. The predetermined median radius R₀ᵢ can be obtained by various types of known measurement, such as optical measurement or X-ray tomography measurement.

The median radius R₀ can be determined from the formula defined in equation 2 below:

$${R}_{0} = \frac{A}{B - {g}_{1} ( l , φ , \vert T \vert )} \qquad ( 2 )$$

wherein A is a distance between 20 μm and 500 μm and in particular between 100 μm and 150 μm, B is a dimensionless number between 0.1 and 1 and in particular between 0.2 and 0.6, and g₁ is a function having as variables the width l expressed in mm, the gas volume fraction φ and the modulus of the complex transmission |T|.

The function g₁ can be defined as described in equation 3 below:

$${g}_{1} = \frac{E}{l \cdot φ} ln \vert T \vert \qquad ( 3 )$$

wherein E is a constant value homogeneous to a distance, preferably between 0.01 mm and 0.5 mm, and in particular between 0.070 mm and 0.090 mm.

The method 100 can be adapted to measure a median radius R₀ between 20 μm and 120 μm, with A equal to 120 μm, B equal to 0.5 and E equal to 0.072 mm. Curve (a) in FIG. 4 shows the variation in |T| for a model including these parameters.

The method 100 can be adapted to measure a median radius R₀ between 50 μm and 200 μm, with A equal to 110 μm, B equal to 0.25 and E equal to 0.072 mm. Curve (b) in FIG. 4 shoes the variation in ln|T| for a model including these parameters.

Determination of the median radius R₀ can be implemented on the basis of an attenuation factor α representative of the linear attenuation of the pulse amplitude in the foamed medium 2. The phenomenological model developed can take into account the attenuation α of the pulse as it propagates through the cavity 3, which is filled with a bubble-free liquid medium identical to the liquid medium of the liquid phase of the foamed medium. Each series used to determine the predetermined function by a fit may comprise the attenuation α. The median radius R₀ can be determined from the formula defined in equation 4 below:

$${R}_{0} = \frac{A}{B - {g}_{2} ( l , φ , \vert T \vert , α )} \qquad ( 4 )$$

The function g₂ can be defined by equation 5 below:

$${g}_{2} = \frac{E}{l \cdot φ} ln \vert T \vert + α l \qquad ( 5 )$$

### Architecture of the Device 6 for Determining the Median Radius R₀

Referring to FIG. 2, another aspect of the invention is a device 6 for determining the median radius R₀ of the collection of bubbles 1 comprised in the foamed medium 2. The device 6 is suitable for implementing method 100.

### Foamed Medium 2

The foamed medium 2 is liquid and suitable for curing to form a solid construction material or solid polymer foam. The foamed medium 2 can be non-transparent, and preferably opaque. In fact, the method 100 makes it possible to determine the median radius R₀ of collection of bubbles 1 without having to use the optical transmission properties of foamed medium 2.

The predetermined gas volume fraction φ of the foamed medium 2 is between 0.05 and 0.8 inclusive, in particular between 0.1 and 0.8 inclusive and preferentially between 0.3 and 0.8. In fact, the method 100 enables measurement of media with predetermined gas volume fractions φ that are very high compared with the prior art.

The foamed medium 2 may comprise a cement blend, a plaster blend, a lime blend or a mortar blend. In this way, it is possible to control the median radius R₀ of the bubbles 1 introduced into a blend so as to lighten the material formed by the solidified blend without degrading the mechanical performance of this material.

The foamed medium 2 can be produced by mixing water in a 3/7 proportion and gypsum in a 4/7 proportion in a mechanical mixer (e.g. a Tefal blender, model BL305801), adjusting the volume of water and gypsum relative to the total volume of the mixer so that the gas fraction is between 0.05 and 0.8.

The foamed medium 2 can comprise polyurethane foam and polyisocyanurate foam.

### Cavity 3

The device 6 comprises a cavity 3 adapted to receive the foamed medium 2. The cavity 3 can have a width l. The width l can be measured along the direction of pulse propagation.

The transmitter 4 and receiver 5 can be arranged on either side of the width l of the cavity 3, so that the pulse propagates across the width l of the cavity 3, preferably into the foamed medium 2. The transmitter 4 may comprise a first transducer 11. The receiver 5 may comprise a second transducer 12. The first transducer 11 can be arranged to transmit a pulse towards the second transducer 12.

The width l can be less than 5 mm, in particular less than 2 mm, and preferentially less than 0.8 mm. In this way, it is possible to determine the median radius R₀ by acquiring a signal representative of a ballistic portion of the transmitted pulse. Indeed, for widths l greater than 5 mm, the signal acquired by detector 5 is mostly representative of the superposition of several diffusion paths in foamed medium 2, which is driven by a gas volume fraction of between 0.05 and 0.8. This part of the transmitted signal can be called the “coda”. With a width l of less than 5 mm, it is possible to acquire a coda-free part of the transmitted signal. This part is also called the “ballistic part of the signal”. Only the ballistic part of the signal can be used to determine the median radius R₀.

### Ultrasound Pulse Transmitter 4

The device 6 comprises an ultrasound pulse transmitter 4 arranged to transmit an ultrasonic wave towards the cavity 3.

The transmitter 4 can be configured to transmit a longitudinal ultrasound pulse and/or a transverse ultrasound pulse. During the pulse transmission step 101, when the ultrasound pulse is longitudinal, the method 100 may comprise a step 103 of detecting the pulse propagated through the cavity 3. The detector 5 can then be arranged on the opposite side of the cavity 3 as the transmitter 4. When the ultrasound pulse is transverse, the method 100 may comprise a step 103 to detect the pulse reflected by the cavity 3. The detector 5 can then be arranged on the same side of the cavity 3 as the transmitter 4.

The transmitter 4 may comprise a voltage generator 10. The first transducer 11 may be an immersion transducer. The first transducer 11 may be focused to infinity. The first transducer 11 may be, for example, an Olympus V308-SU transducer.

The device 6 can be configured to measure a predetermined maximum median radius R₀ₘₐₓ of the collection of bubbles, and the first transducer 11 can extend along a length L in a direction perpendicular to a direction of pulse transmission by the transmitter 4. The length L can be greater than 30·R₀ₘₐₓ and preferentially greater than 50·R₀ₘₐₓ. In this way, it is possible to increase the proportion of the ballistic part in the detected pulse and reduce the proportion of the coda in the detected pulse. In fact, the long length L of the first transducer 11, compared with the maximum bubble radius R₀ₘₐₓ, enables signals to be averaged, each one driven by an individual bubble diffusion. The predetermined maximum median radius R₀ₘₐₓ may be equal to 300 μm and the length L may be greater than 9 mm and preferably greater than 15 mm.

The voltage generator 10 can be a high-voltage electrical pulse generator, configured to transmit an electrical pulse with an amplitude greater than 50 V, in particular greater than 100 V and preferably greater than 400 V. The voltage generator 10 can be configured to transmit an electrical pulse with a negative mean voltage, so that the voltage of the electrical pulse is always negative. In this way, it is possible to counteract the attenuation of the pulse amplitude caused by transmission through the cavity 3 or reflection on the cavity 3, and thus enable detection of the pulse by the detector 5. The voltage generator 10 can be configured to transmit an electrical pulse with a duration of between 0.03 μs and 10 μs. The voltage generator 10 may be a JSR Ultrasonics DPR300 generator.

### Ultrasound Pulse Detector 5

The device 6 comprises an ultrasound pulse detector 5 arranged to detect an ultrasound pulse. The detector 5 may comprise a second transducer 12.

The transmitter 4 and the detector 5 may be arranged on either side of the width l of the cavity 3 so that the pulse propagates in the foamed medium 2 along the width l of the cavity 3. This configuration corresponds to pulse measurement through the cavity 3 via transmission. The first transducer 11 and the second transducer 12 may be identical. The second transducer 12 may be an Olympus V308-SU transducer. The second transducer 12 may extend along a length L in a direction perpendicular to a direction of pulse transmission by the transmitter 4. The length L can be at least greater than 30·R₀ₘₐₓ and preferentially greater than 50·R₀ₘₐₓ. In this way, it is possible to increase the proportion of the ballistic part in the detected pulse and reduce the proportion of the coda in the detected pulse.

The transmitter 4 and detector 5 can be arranged on the same side of cavity 3, so that the pulse is reflected by cavity 3. This configuration corresponds to pulse measurement through the cavity 3 via reflection. In a reflection measurement, the pulse does not propagate in the cavity 3, but the foamed medium 2 in the cavity 3 causes a change in the reflected signal to detector 5. In this configuration, the first transducer 11 and the second transducer 12 may be the same transducer. The transducer can be directly connected to the control unit 7.

The detector 5 may also comprise an array of second transducers 12. In this way, the pulse propagated through the cavity 3 can be imaged. The array of second transducers can be a linear array in which the second transducers are arranged in a direction perpendicular to the width l.

### Control Unit 7

The device 6 comprises a control unit 7 configured to acquire at least one component selected from an amplitude of the pulse detected by the detector 5 and a phase of the pulse detected by the detector 5.

The control unit 7 is configured to determine, on the basis of a pulse detected by the detector 5 and a reference pulse, at least one feature selected from transmission T of the pulse through the cavity 3 and reflection R of the pulse on a surface delimiting the cavity 3. The control unit 7 can also be configured to determine the modulus of the complex transmission |T|.

The control unit 7 is configured to determine the median radius R₀ of the collection of bubbles 1 from the determined element(s) and the predetermined gas volume fraction φ. To this end, the control unit 7 can be configured to calculate the median radius R₀ from the previously described model. The control unit 7 may comprise at least one processor and at least one memory, enabling calculation of the component and/or the median radius R₀. The memory may comprise data representative of the reference pulse(s).

The control unit 7 can be connected to the detector 5, in particular to the second transducer 12 of the detector 5. The control unit 7 can be configured to control the voltage generator 10 of the transmitter 4. The control unit 7 may comprise a multiplexer for acquiring a pulse-related signal from first transducer 11 and/or second transducer 12.

In determination step 104, the element can be determined from a signal representative of the start of the pulse up to a predetermined pulse duration. The predetermined duration can be less than 2·(1/fₜ) and preferably less than (1/fₜ). In this way, it is possible to avoid taking any pulse echoes into account when determining the component. The control unit 7 can be configured to determine the median radius R₀ from the component determined only from the start of the pulse to the predetermined duration.

### Flow of Foamed Medium 2

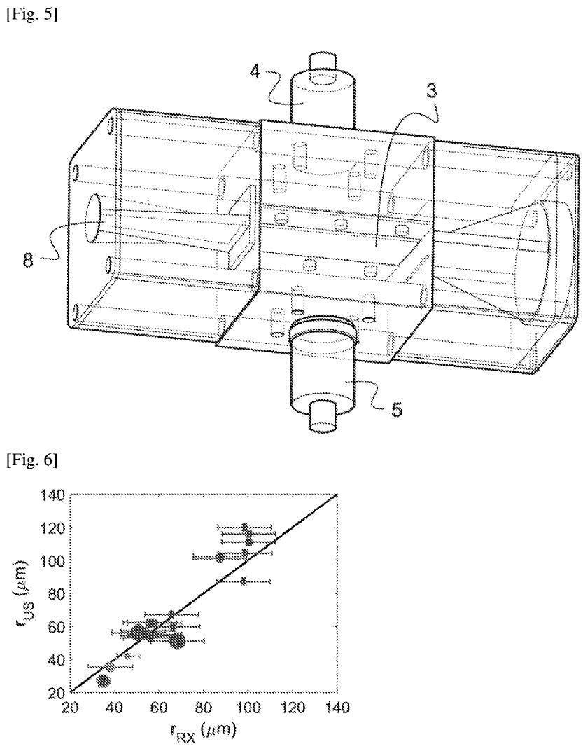

With reference to FIG. 5, the device 6 may comprise a channel 8 adapted for a flow of the foamed medium 2. The channel 8 comprises the cavity 3. The channel 8 can be tapered along the main flow direction of channel 8, with a tapered portion of the channel forming the cavity 3.

During the transport 101 of the foamed medium 2 in the cavity 3, a flow of foamed medium 2 can be entrained into the channel 8. Thus, it is possible to control the median bubble radius R₀ of a foamed medium 2 during its production by diverting a sample of this foamed medium 2 to channel 8. The flow of foamed medium 2 can be driven by a flow generator 9.

The flow of foamed medium 2 can be sequential. If so, the flow is distinct from the transmission 102 and detection 103 steps.

The flow of foamed medium 2 can be continuous. If so, the transmission 102 and detection 103 are implemented during the flow. In this way, it is possible to average the effect of bubbles on the diffusion of the pulse(s), thus increasing the accuracy of the determination of the median radius R₀.

### Calibrating the Device 6

With reference to FIG. 6, the device 6 can be calibrated on the basis of median radius measurements r_{RX} implemented by X-ray tomography. FIG. 6 shows a calibration curve determined from median radius measurements implemented by X-ray tomography and from the determination of the associated median radii for the same liquid media 2. The median radii are determined using the model described by the formulas in equations (2) and (3) above.

1. A method for determining a median radius R₀ of a collection of bubbles comprised in a liquid foamed medium adapted to be cured and to form, after curing, a solid construction material or a solid polymer foam, the foamed medium having a liquid phase and a gaseous phase formed by the collection of bubbles, and having a predetermined gaseous volume fraction φ of between 0.05 and 0.8 inclusive, the method comprising:
a) conveying the foamed medium into a cavity,
b) transmitting an ultrasound pulse to the cavity by an ultrasound pulse transmitter,
c) detecting the ultrasound pulse by an ultrasound pulse detector,
d) determining, on the basis of the ultrasound pulse detected in step c) and a reference pulse, at least one feature selected from transmission T of the ultrasound pulse through the cavity and reflection R of the ultrasound pulse on a surface delimiting the cavity,
e) determining the median radius R₀ of the collection of bubbles from the at least one feature determined in step d) and the predetermined gas volume fraction φ.

2. The method according to claim 1, wherein the cavity has a width l, and wherein the ultrasound pulse transmitter and ultrasound pulse detector are arranged on either side of the width l of the cavity so that the ultrasound pulse propagates in the foamed medium along the width l of the cavity, and wherein, in step d) the transmission T of the ultrasound pulse through the cavity is determined, the method being adapted to determine a predetermined maximum median radius R₀ₘₐₓ of the collection of bubbles, wherein, in step b), the ultrasound pulse is transmitted at a transmission frequency fₜ strictly greater than a permitted propagation frequency fₚₚ equal to (\sqrt{3φ}·c₀)/(2π·R₀ₘₐₓ), c₀ being the ultrasound pulse velocity in the liquid phase of the foamed medium.

3. The method according to claim 2, wherein the cavity has a width l, and wherein the ultrasound pulse transmitter and ultrasound pulse detector are arranged on either side of the width l of the cavity so that the ultrasound pulse propagates in the foamed medium along the width l of the cavity, and wherein, in step d) the transmission T of the ultrasound pulse through the cavity is determined, the method is adapted to determine a predetermined maximum median radius R₀ₘₐₓ of the collection of bubbles, wherein, in step b), the ultrasound pulse is transmitted at a transmission frequency fₜ strictly less than a sensitivity limit frequency fₗₛ of between 4·(\sqrt{3φ}·c₀)/(2π·R₀ₘₐₓ) and 10·(\sqrt{3φ}·c₀)/(2π·R₀ₘₐₓ), and preferably between 4·(\sqrt{3φ}·c₀)/(2π·R₀ₘₐₓ) and 6·(\sqrt{3φ}·c₀)/(2π·R₀ₘₐₓ).

4. The method according to claim 2, devoid of a step wherein an ultrasound pulse with a frequency lower than the permitted propagation frequency fₚₚ is transmitted.

5. The method according to claim 2, wherein the transmission frequency fₜ is between 0.4 MHz and 56 MHz.

6. The method according to claim 1, wherein the cavity has a width l, and wherein the ultrasound pulse transmitter and ultrasound pulse detector are arranged on either side of the width l of the cavity so that the ultrasound pulse propagates in the foamed medium along the width l of the cavity, and wherein in step d), the transmission T of the ultrasound pulse through the cavity is determined, the width l being less than 5 mm.

7. The method according to claim 6, wherein, in step e), the median radius R₀ is determined from the gas volume fraction φ, from the at least one feature, and from the width l.

8. The method according to claim 7, wherein, in step e), the median radius R₀ is determined from an attenuation factor α representative of the attenuation of the ultrasound pulse amplitude in the foamed medium along the width l.

9. The method according to claim 1, wherein in step a), a flow of foamed medium is driven into a channel comprising the cavity.

10. The method according to claim 1, wherein the foamed medium comprises at least one member selected from a foam and a blend.

11. The method according to claim 1, wherein in step b) the ultrasound pulse has a duration of between 0.03 μs and 10 μs.

12. The method according to claim 1, wherein, in step d), the at least one feature is determined from the start of the ultrasound pulse to a predetermined duration.

13. The method according to claim 1, wherein the cavity has a width l, and wherein the ultrasound pulse transmitter and the ultrasound pulse detector are arranged on either side of the width l of the cavity so that the ultrasound pulse propagates along the width l of the cavity and wherein the ultrasound pulse is a longitudinal ultrasound pulse.

14. The method according to claim 1, wherein the step e) of determining the median radius R₀ of the collection of bubbles is carried out without using the resonant frequency of the collection of bubbles.

15. The method according to claim 14, wherein the ultrasound pulse is transmitted at a transmission frequency fₜ of between 0.4 MHz and 56 MHz.

16. The method according to claim 1, wherein the cavity has a width l, and the ultrasound pulse transmitter and ultrasound pulse detector are arranged on either side of the width l of the cavity, so that the ultrasound pulse propagates in the foamed medium along the width l of the cavity, and wherein in step d), the transmission T of the ultrasound pulse through the cavity is determined, and, in step e), a modulus of a complex transmission of the ultrasound pulse through the cavity is determined at least from the transmission T, and the median radius R₀ is determined from the ratio defined by:
$$\frac{A}{B - {g}_{1} ( l , φ , \vert T \vert )}$$
A being a distance between 20 μm and 500 μm, B being a dimensionless number between 0.1 and 1, and g₁ being a function having as variables the width l expressed in mm, the gas volume fraction φ and the modulus of the complex transmission, the function g₁ is equal to
$$\frac{E}{l \cdot φ} ln \vert T \vert$$
E being a constant value.

17. A device for determining a median radius R₀ of a collection of bubbles comprised in a liquid foamed medium adapted to be cured and to form, after curing, a solid construction material or a solid polymer foam, the foamed medium having a liquid phase and a gaseous phase formed by the collection of bubbles, and having a predetermined gaseous volume fraction φ of between 0.05 and 0.8 inclusive, the device comprising:
a cavity adapted to receive the foamed medium,
an ultrasound pulse transmitter arranged to transmit an ultrasonic wave towards the cavity,
an ultrasound pulse detector arranged to detect an ultrasound pulse and,
a control unit configured to:
determine, on the basis of the ultrasound pulse detected by the ultrasound pulse detector and a reference pulse, at least one feature selected from transmission T of the ultrasound pulse through the cavity and reflection R of the ultrasound pulse on a surface delimiting the cavity, and to
determine the median radius R₀ of the collection of bubbles from the determined element and the predetermined gas volume fraction φ.

18. The device according to claim 17, wherein the cavity has a width l, the ultrasound pulse transmitter and ultrasound pulse receiver being arranged on either side of the width l of the cavity so that the ultrasound pulse propagates across the width l of the cavity.

19. The device according to claim 17, comprising a channel adapted for the flow of foamed medium, the channel comprising the cavity.

20. The device according to claim 17, configured to measure a predetermined maximum median radius R₀ₘₐₓ of the collection of bubbles, the ultrasound pulse transmitter comprising a first transducer extending along a length L in a direction perpendicular to a direction of ultrasound pulse transmission by the transmitter, the length L being greater than 30·R₀ₘₐₓ.

21. The device according to claim 17, wherein the control unit is configured to determine the median radius R₀ of the collection of bubbles from the determined at least one feature and the predetermined gas volume fraction φ without using the resonant frequency of the collection of bubbles, the ultrasound pulse being transmitted at a transmission frequency fₜ of between 0.4 MHz and 56 MHz.

22. The device according to claim 17, wherein the cavity has a width l, and the ultrasound pulse transmitter and ultrasound pulse detector are arranged on either side of the width l of the cavity, so that the ultrasound pulse propagates in the foamed medium along the width l of the cavity, and wherein the control unit is configured to determine the transmission T of the ultrasound pulse through the cavity, determine a modulus of a complex transmission of the ultrasound pulse through the cavity at least from the transmission T, and determine the median radius R₀ from the ratio defined by:
$$\frac{A}{B - {g}_{1} ( l , φ , \vert T \vert )}$$
A being a distance between 20 μm and 500 μm, B being a dimensionless number between 0.1 and 1, and g₁ being a function having as variables the width l expressed in mm, the gas volume fraction φ and the modulus of the complex transmission, the function g₁ is equal to
$$\frac{E}{l \cdot φ} ln \vert T \vert$$
E being a constant value.
